(19) United States
(12) Patent Application Publication
(10) Pub. No.: US 2014/0162752 A1
(43) Pub. Date: Jun. 12, 2014

(54) ONLINE MARKETPLACE WITH INTERNALLY MAINTAINED VIRTUAL ECONOMY AND VIRTUAL CURRENCY

(71) Applicant: Brian David Feldman, Potomac, MD (US)

(72) Inventor: Brian David Feldman, Potomac, MD (US)

(21) Appl. No.: 13/928,817

(22) Filed: Jun. 27, 2013

Related U.S. Application Data
(60) Provisional application No. 61/735,638, filed on Dec. 11, 2012.

(51) Int. Cl. G06Q 20/06; G07F 17/32

(52) U.S. Cl. CPC G06Q 20/06; G07F 17/3244
USPC 463/20; 705/26.3; 463/17

(57) ABSTRACT

A computer-implemented method of purchasing real-world items includes the steps of defining a virtual currency with no stable derivative to a government-recognized currency, electronically assigning a quantity of the currency to at least one user account, offering at least one tangible item in a multi-user competitive purchasing process, accepting an offer from a user associated with the user account, the offer being a promise to exchange a quantity of virtual currency for the tangible item, carrying out the multi-user competitive purchasing process, determining a winner of the competitive purchasing process, and assigning ownership of the tangible item to the winner of the competitive purchasing process.

### CROSS-REFERENCE TO RELATED APPLICATION

This application claims priority to U.S. Provisional Patent Application No. 61/735,638 filed Dec. 11, 2012, the entirety of which is incorporated by reference.

### FIELD OF THE INVENTION

The present invention relates generally to software-generated virtual environments, and, more particularly, relates to a system where virtual currency that has no correlation or reasonably identifiable exchange rate to real world currencies can be earned and exchanged for real-world merchandise and services.

### BACKGROUND OF THE INVENTION

Consumers are currently able to utilize a range of internet-connected devices to purchase physical or digital goods and services from online “storefronts.” Upon selection to purchase the goods or services, money is transferred from the consumer's account to the merchant's account. This exchange of money can go directly from one account to another. Often times however, an intermediary account is used to assist in the digital movement of currency between the consumer and the merchant accounts.

Some of these intermediary systems, such as PAYPAL, denote the amount of currency within an account in their respective, real-world denominations. In other words, one hundred dollars and 50 cents ($100.50) held within a PAYPAL account is represented as one hundred dollars and 50 cents ($100.50).

Today, every online storefront that sells valuable physical and/or virtual goods from a range of suppliers accepts some form of currency from consumers that has an identifiable exchange rate to real world currencies.

Other systems might promote a branded “virtual” currency and have a predefined exchange rate to a real-world currency. Some examples of this are online games such as “WORLD OF WARCRAFT” and LINDEN LABS' “SECOND LIFE” or social networks, such as FACEBOOK, which all now boast millions of registered users. Often, games and networks such as these operate with complex internal economies that make use of their own internal virtual currencies. Due to the size of these games and the number of subscribers, many times these currencies can become extremely valuable. Additionally, these games can offer a way for players to purchase currency within the games using real world currency. One example of such a virtual currency is FACEBOOK Credits. A hypothetical branded virtual currency called “Internet Points” may have an exchange rate of $1.00 equals 100 Internet Points. The exchange rate may fluctuate, and the system may not allow for a consumer to cash out, but, to a reasonable extent, the value of the virtual currency “Internet Points,” directly correlates to the value of a real world currency.

Today, every online storefront that sells valuable physical and/or virtual goods from a range of suppliers accepts some form of currency from consumers that has an identifiable exchange rate to real world currencies. However, the prior art does not provide an internally maintained virtual economy and virtual currency in which an online marketplace accepts only an internally maintained virtual currency that has no exchange rate or reliable correlation to one or more real world currencies. The prior art also fails to provide virtual currency used within a marketplace which can never be purchased with real world currency or cash out for a direct and/or reliable exchange rate. The prior art additionally fails to provide virtual currency that can only be earned through approved, trackable actions, and used to purchase real world goods or services offered within the marketplace.

Therefore, a need exists to overcome the problems with the prior art as discussed above.

### SUMMARY OF THE INVENTION

The invention provides an online marketplace with internally maintained virtual economy and virtual currency that overcomes the hereinafore-mentioned disadvantages of the heretofore-known devices and methods of this general type and that creates a virtual economy and maintains the exchange, transfer, creation, and destruction of a virtual currency that has no correlation or reasonably identifiable exchange rate to real world currencies. The virtual currency within this system will be referred as Virtual Currency.

The invention described below is a method for implementing and maintaining an online marketplace within an internally maintained virtual economy and virtual currency. This online marketplace accepts only an internally maintained virtual currency with an internally-defined exchange rate that has no stable derivative to a government-recognized currency, i.e., it is not directly or predictably tied to any real-world currency markets. The virtual currency used within this marketplace cannot be cashed out for a direct exchange rate. It can be earned through approved, track-able actions, and used to purchase “tangible,” i.e., real-world, goods or services offered within the marketplace. Real-world goods include any physical goods or services performed that have a value outside of the virtual world in which they were obtained. Tangible items that are “real-world” need not be physically touchable, but can include items such as MP3s, NETFLIX Subscriptions, electronic ITUNES Gift Cards, or a digital code to get a discount from stores, such as AMAZON.com. In other words, tangible items are things with real-world value.

In an exemplary embodiment, a system and method for exchanging virtual currency for goods or services includes an online system that maintains its own internal economy, actively separate and not derived from any real-world government economy. This system allows for users to create accounts, earn, and potentially gift or gamble a virtual currency through tracked actions that may be online, offline, internal, through third parties, active, and/or passive. A user can then use their virtual currency to purchase physical and/or digital goods and/or services offered through an online storefront. Online storefronts may be competitive or game-like in nature so as to actively prevent the ability to reasonably calculate or act upon a conversion or exchange rate of the virtual currency into a real world currency. The system employs check and balances, similar to taxes, to ensure the maintenance, strength and stability of the virtual economy. The virtual currency cannot be purchased with real world currencies, only earned through approved actions determined by the system.

The method comprises storing data associated with users in a database, updating the data associated with the users to include changes in the amount of a virtual currency owned by the users caused by interactions in a virtual environment and allowing the users to exchange the virtual currency for real-world items through competitive purchasing processes.

In yet another exemplary embodiment, A computer-implemented method of purchasing real-world items includes the steps of defining a virtual currency with no stable derivative to a government-recognized currency, electronically assigning a quantity of the currency to at least one user account, offering at least one tangible item in a multi-user competitive purchasing process, accepting an offer from a user associated with the user account, the offer being a promise to exchange a quantity of virtual currency for the tangible item, carrying out the multi-user competitive purchasing process, determining a winner of the competitive purchasing process, and assigning ownership of the tangible item to the winner of the competitive purchasing process.

In accordance with a further embodiment of the present invention, the quantity of the currency in the winning user's user account is decreased by an amount corresponding to the amount of virtual currency needed to win the competitive purchasing process.

In accordance with another embodiment of the present invention, the multi-user competitive purchasing process includes an auction-style bidding process, a lottery-style selection competition, a slot-machine-like selection competition, a roulette-style selection completion, or one of many other gambling-type determination processes.

In a further embodiment of the present invention, the method includes funding at least a portion of a lottery jackpot from at least a portion of virtual currency received from the at least one auction bid, selecting a winner of the lottery jackpot from a group of users who each placed at least one auction bid, and providing the winner an opportunity to claim the lottery jackpot. A feature of the present invention can include receiving, via a server, instructions to apply virtual currency to attack an ability of the lottery winner to claim the lottery jackpot. Another feature of the present invention can include adding at least a portion of the virtual currency from the attack to the lottery jackpot. Yet another feature of the present invention can include selecting a new winner of the lottery jackpot and storing the virtual currency of the lottery jackpot with one or more users in one or more databases.

In accordance with another embodiment, the present invention includes actively preventing a reliable conversion or exchange rate between the virtual currency and the government-recognized currency.

In accordance with one additional embodiment of the present invention, the step of electronically assigning a quantity of the currency to the at least one user account includes rewarding a user of the at least one user account for performing an offline action, interacting with a third party, or other actions not performed within the game.

In yet another exemplary embodiment, a computer-implemented method of transacting in a virtual economy is disclosed. The method comprises storing a virtual currency associated with at least one user account in at least one database, causing deliberate, or otherwise purposeful, destabilization of the virtual currency for preventing a defined exchange rate between the virtual currency and real world currency.

In a further embodiment of the present invention, the computer-implemented method comprises facilitating a transfer of the virtual currency from the user account to purchase at least one of a real world item. The method includes receiving at least one auction bid having an associated virtual currency value for the at least one real world item. The method further includes identifying a tax on at least a portion of the at least one auction bid, and in an embodiment, the tax may be applied to a losing auction bid at a tax rate. In yet another embodiment, the tax rate is identified only after a user bids on the at least one real world item. Alternatively, the tax rate may be provided prior to a user bid, however, the constant fluctuation of the tax rate, and or other virtual economy parameters, including the amount of total virtual currency available to the virtual economy at any given moment in time, prevents reliably associating an exchange rate between the virtual currency and any real world currency. In an embodiment of the present invention, the total amount of virtual currency in the virtual economy is unobservable to an end user, or other individuals, which would otherwise use the total amount of virtual currency to establish an exchange rate between the virtual currency and the real world currency. In an embodiment, at least one variable virtual tax for destabilizing the virtual currency is provided.

In yet another embodiment of the present invention, the virtual tax causes the deliberate destabilization of the virtual currency. For example, as the virtual tax varies, end users would value the virtual currency differently resulting at least from the time requirements to earn virtual currency wherein time restraints are subjective measures of value that cannot be freely associated with an exchange rate.

In an embodiment, deliberate and/or purposeful, as it relates to destabilization of the virtual currency, is defined as permitting, causing, intending to cause, or seeking to cause an alteration of at least one of a plurality of virtual currency parameters. The deliberate destabilization prevents a reliable real world exchange rate associated to the virtual currency.

In an embodiment of the present invention, a computer-implemented method comprises providing a virtual economy having a plurality of parameters, the virtual economy configured to dispense virtual currency, the virtual currency having a user defined value, the virtual currency operable to purchase real world items. One feature of the present embodiment includes altering at least one of the parameters of the virtual economy for preventing a defined exchange rate between the virtual currency and real world currency.

In an embodiment of the present invention, a system comprises one or more servers configured to host a virtual economy having a virtual currency, the virtual currency having a user defined value, the virtual currency operable to purchase real world items. In a feature of the present embodiment, one or more servers are configured to alter the virtual economy for preventing a definable exchange rate of the virtual currency value against a real world currency.

Although the invention is illustrated and described herein as embodied in a system and method for providing a purposefully destabilized virtual currency for a virtual economy, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic of the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

Advantages of embodiments of the present invention will be apparent from the following detailed description of the exemplary embodiments. The following detailed description should be considered in conjunction with the accompanying figures in which:

FIG. 1 is an exemplary flow diagram representing user interaction with the virtual environment to award real-world prizes based on transactions with virtual currency in accordance with an additional embodiment of the present invention; and

FIG. 2 is an exemplary flow diagram representing user interaction with the virtual environment to award real-world prizes based on transactions with virtual currency in accordance with yet another embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a digital control system and the digital signal processing (DSP) devices. It will be recognized that various actions described herein can be performed by specific circuits (e.g., application specific integrated circuits (ASICs)), by program instructions being executed by one or more processors, or by a combination of both. Additionally, these sequences of actions and processes described herein can be considered to be embodied entirely within any form of computer platform having stored therein a corresponding set of computer instructions that upon execution would cause an associated processor to perform the functionality described herein. Thus, the various aspects of the invention may be embodied in claimed subject matter. In addition, for each of the embodiments described herein, the corresponding form of any such embodiments may be described herein as, for example, “logic configured to” perform the described action.

In accordance with the present invention, a platform with an associated currency or medium of exchange that can be used in a networked computer system, for example, while playing a massively multiplayer online role-playing game or social network, is provided. This virtual currency exists in a persistently virtual economy and can be traded or exchanged between individual users of the computer system and used to buy real-world items. The virtual currency can be earned or otherwise rewarded. However, the virtual currency may also be exchanged or otherwise tendered in the real world despite the lack of reliable mathematical connection to a fixed real-world economy.

While the virtual currency may be used to bid on items that provide real world value, there otherwise exists no reliable real world economic connection. The value of the currency is internally maintained and regulated by the free market of the users bidding or engaging in other purchasing arrangement to buy the items. Additionally, the business cannot assign a value to the item or regulate the free-market association of the item to the virtual currency. Further, the virtual currency cannot be bought, purchased, and/or traded with/for cash or other real world currency because there exists no reliable real world value to the virtual currency.

Additionally, the currency may be generated in any fashion and in any denominations, and may have a value that is independent of any one real world currency. The currency can be exchanged for goods or services performed or delivered outside of the networked computer system, or for benefits such as coupons or discounts. The platform and the currency can be used by entities such as businesses to track the activities of users of the computer system and use the information gathered to provide benefits to the users. Additionally, the currency used by the computer system may emulate physical currency, insofar as interactions between players, businesses, and any other entities that involve currency can be such that the party receiving any currency may be free to save the currency or use it for any desired purpose. In some embodiments, some portions of the currency are absorbed by the computer system, for example, when the user commits to purchases, but later decides differently.

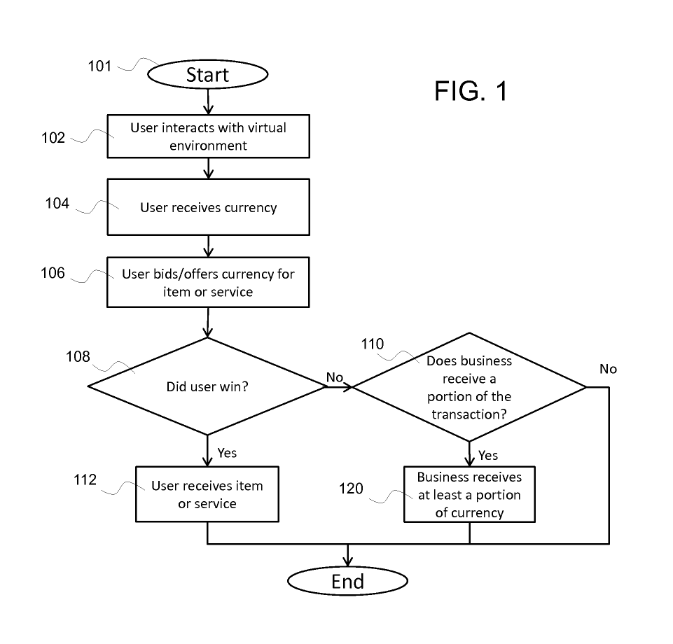

FIG. 1 depicts a flow diagram of an exemplary embodiment of the present invention illustrating user interaction with a transaction system of the present invention. In one embodiment, the transaction system includes a virtual currency with no stable derivative to a government-recognized currency. That is, the currency cannot be associated directly and/or reliably with a real world value and cannot be exchanged for actual currency. While, at any given moment, there is an equation that might be used to correlate the virtual currency with a real-world economy, the present invention specifically prevents a stable correlation that can last more than a single transaction within the system. In other words, the system includes a competitive marketplace that facilitates purchasing of items, i.e., goods or services in the real-world, while preventing a unified or reliable connection to a government-regulated exchange rate, i.e., one referenced by most commercial banking institutions. The online system maintains the exchange, transfer, creation, and destruction of a virtual currency within the economy that has no reliable correlation or reasonably identifiable exchange rate to real world currencies. An Internet connection may be used, but is not necessarily required, in order for the user to interact with all of the features of the online system, including related software.

In an embodiment, the economy alternates between a stabilized state and destabilized state. For example, the system may alter a transaction tax from one day to the next day, or one hour to the next hour, causing disruption to any perceived exchange rate with actual currency. Further, the currency that is taxed may evaporate upon collection and any amount of new currency may be virtually printed or issued at will. Additionally, the currency cannot be associated directly and/or reliably to a real world value because the currency cannot be bought, but instead must be won, earned, or otherwise awarded. The online system tracks and/or monitors the action or actions that lead to earning virtual currency. Such actions may include, without limitation, gaming, viewing advertisements, clicks, visiting webpages, and more. Any promotion, prize, or item having real world value cannot be used reliably to determine the real world value of the currency because the items are never guaranteed to be sold for the same number of currency credits during the next transaction. This is an effect of the unreliability of a bidding, lottery, or other similar style purchasing system.

In an embodiment, the online system includes a virtual store front. The online system, through the virtual storefront, maintains an inventory of available promotions, prizes, and/or items that may be placed for purchase and/or auction. The online system may regulate which articles are available on the virtual storefront, as well as when they will become available for purchase and/or auction, where articles is defined as one or more promotions, prizes, and/or items. In addition to maintaining said articles in the inventory, some implementations might also provide multiple storefronts wherein said articles are provided across the multiple storefronts for purchase or bidding with virtual currency in accordance with the principles of the present invention. The virtual storefront may graphically represent different articles on one user's computing system than another user's computing system dependent upon criteria internal to the online system, such as user account auction-style bidding history, the auction-style-bidding history of a plurality of user accounts in a particular geographic location, or the total amount of virtual currency available to a user account. For example, the virtual storefront may not display or allow for selection of a particular article if that user had already purchased and/or bid on that same or similar article within a predetermined time period. For further example, certain articles may not be displayed to users where their user accounts have significantly more virtual currency than the majority of other users to prevent users dominating the auction-style bid and provides an additional layer for preventing a correlation between the virtual currency and a real-world exchange rate.

In one embodiment, as shown in FIG. 1, the process begins at step 101 and moves directly to step 102, where a central server interacts with the user by way of the user PC or the user mobile device. At step 104, the user receives currency in relation to his/her interaction with the virtual environment and the currency amount is stored within the user's account within a database. Such interaction includes, without limitation, playing games, interacting with social media, sending messages, opening messages, other ways explained herein, and other ways currently known or to be developed. There are virtually unlimited ways in which game play/system user could earn the user currency.

At step 106, as the user earns currency, the user has the option to transact, i.e., trade, at least a portion of the user's currency for at least one promotional item. The online system may include actions. Actions refer to any online or offline action by a user that leads to earning virtual currency. The actions may be added or removed by an administrator or the online system software. In some embodiments, the online system offers the user one or more ways to gamble, wager their virtual currency through online and/or offline transactions. The transactions may, in one embodiment, take the form of a bid comprised of at least a portion of that user's currency to win, or otherwise obtain, at least one promotional item. Alternatively, a slot-machine-like chance game may provide the opportunity to win the promotional item where the rules prevent a direct price for offered merchandise and impedes the ability to apply a reasonable conversion rate to a real world currency. The promotional item may include, without limitation, real world gift certificates, real word gift cards, real world items, and virtual world items. Real world items may include real world promotional items. “Promotional items,” as used herein, is intended to indicate (1) a product or service that is not yet well known in the marketplace and/or is being provided by a third party as a way of informing the public of the item or service or (2) a product or service that is being provided to auction host by a third party free of charge or at a discount. In an embodiment, the transaction includes a plurality of bids from a plurality of users/players where the last highest bid of a user/player wins the item.

The system allows for offline user gameplay. When the user is offline, the user's actions are tracked and/or monitored. When the user subsequently connects to the online system, the present invention allows for the online system to adjust the virtual currency in the user's account, which is stored in the database. The system also allows adjust the rate of earning virtual currency.

In some embodiments, the online system rewards virtual currency for online and/or offline interactions with third parties. This could be implemented through an Application Programming Interface (“API”) or a Software Development Kit (“SDK”), e.g., a user may earn virtual currency for clicking on a social media “like” button.

In an embodiment, the transaction includes a plurality of users who each place a bid for a promotional item or service where the winner is based on a percentage of the total number of bids. For example, the winner may be the user who bids two-thirds of the average of the total value from the plurality of bids. Alternatively, the winner may be the user who bid the straight average of the total value of the total number of bids. The promotional item is not set at a predetermined price. Instead, the value of the promotional item relates to the virtual currency and the amount of participation of the users.

The present invention is not limited to choosing a winner based on the highest percentage of currency bid, or based on an average, but is instead based on any conceivable mathematical formula for calculating and/or otherwise choosing a winner.

At step 108, winners and/or losers of the transaction are identified. The winners and/or losers may be identified/determined by an algorithm running on the central server or by host interaction/determination. The winner identification/determination may be performed after the close of the virtual currency auction. At step 112, the winning user receives the item bid on. In one embodiment, the winning user automatically receives the redeemable promotional item. For instance, the user may receive a message, such as an email, text message, push message, browser message, app message, WAP message or alert, service message, or the like, that puts the user in possession of the promotion or otherwise puts the user in the position to otherwise become in possession of the promotional item at a later point in time. The message may include a coupon and a scannable or readable code that the user may be able to get a physical copy of, for example, by printing. The printed copy may then be redeemed at a business's physical location following it being scanned or read by an appropriate device. The message may further include a barcode feature that allows the business to scan the coupon directly from the mobile device. The message may further include a redemption feature that allows the user to transfer the coupon, voucher, discount, value, or the like, to the business for redemption. Following such a scanning or reading at the time of redemption, any appropriate accounts may then be updated to reflect that the promotion has been redeemed and thereby preventing future redemption of the same code, coupon, voucher, or etc.

At step 110, the user has been identified as losing the bid for the promotion. A determination is made whether the business receives a portion of the losing bid. If the business receives a portion of the bid, it is determined what portion the business receives. At step 120, the business receives a portion or the entire bid by the user. In the event that a user loses the bid, the user automatically surrenders a percentage of the virtual currency of the bid. In one embodiment, the tax percentage to be levied may not be disclosed to the end user until after the bid is made. In another embodiment, the tax percentage to be levied is disclosed to the end user prior to the use of the virtual currency.

In an embodiment, at step 120, at least a portion of the bid for a promotion may be provided to the business supplying the promotion. The business may be provided with either some and/or the entire winning bid. The business may also be provided with either some and/or the entire losing bid. The business can then redistribute the currency. For instance, the business may provide an amount of currency for “liking” the business' social media page. The business may provide an amount of currency for “checking in,” tagging, or geotagging a location relating to the business. The business may provide an amount of currency for “hashtagging” the business, such as hashtagging that accompanies a photographic or video post on a social media website. The business may further provide an amount of currency configured to be used for real world purchases. For instance, a business may provide virtual currency subsequent to an in-store purchase, which can then be utilized in accordance with the spirit and scope of the present invention in the virtual environment.

If the answer to step 110 is no, none of the bid is provided to the business. However, the real-world transactions, such as social media interaction, real world purchases, and real world interaction, to name a few, could provide virtual currency to the business. That currency may be distributed by the server.

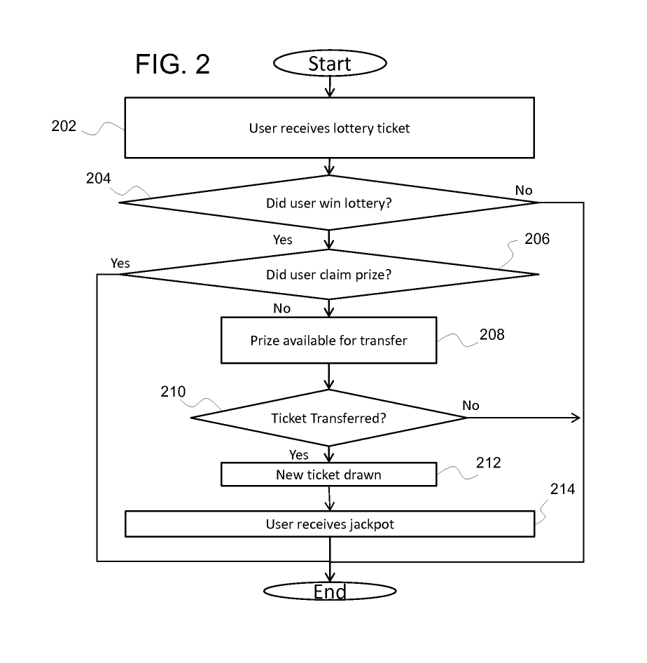

FIG. 2 shows a flow chart illustrating an additional embodiment where, after the user bids on an item, as was shown in FIG. 1, the user receives one or more lottery-type tickets in step 202. Alternatively, the user could directly purchase lottery tickets with virtual currency. In this embodiment, the central server selects a winning lottery entry and provides the winning user with currency and/or an item. When the user bids on the item in the action-style bidding system, the jackpot receives funding. In other words, the central server transfers some or all of the bids to the lottery jackpot. When the user bids on the item, the user receives at least one entry into the jackpot lottery prize pool that randomly, or semi-randomly, awards a prize to a user entered into the lottery prize pool. Certain rules, restrictions, or conditions may be placed on the semi-random selection of lottery prize pool winners to control the winners of the jackpot. For example, users may be restricted to winning the lottery one time over a one-month period. At step 204 the system determines which user won the lottery. In an embodiment, the promotion is not automatically provided to the winning user. Instead, the user must stay vigilant and actively claim the prize. The user may be required to log onto the virtual environment, physically select the promotion, or otherwise virtually select the promotion, and accept the promotion. At step 206, the system determines whether the user claimed the prize. If the winning user has not claimed the prize at step 206, the winning lottery ticket becomes available for transfer at step 208. A predetermined time period may or may not exist to allow the lottery winner a certain amount of time before the ticket is available for transfer to another user. A lottery ticket available for transfer to another user allows the other users of the virtual environment to obtain the lottery ticket. In an embodiment, the central server receives instructions from other users to apply their virtual currency to try to steal the winning lottery ticket. In one example, at step 210, the attempt may be successful after a certain threshold value has been reached which causes the winning lottery ticket to be effectively transferred. At step 212, subsequent to transferring the winning lottery ticket, a new ticket is drawn, which then requires the new holder of the new winning ticket to claim the prize before the winning lottery ticket is effectively transferred to a subsequent user according to the method described at steps 206, 208, and 210. Similarly, the method associated with the ability to transfer the lottery ticket could be implemented to allow users to attack the winner of a promotion at step 208 before the user claims the promotion. At step 228, the system provides the winning user with the jackpot that may include virtual currency and/or a promotion.

The foregoing description and accompanying drawings illustrate the principles, preferred embodiments, and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented method of purchasing real-world items, the method comprising:
defining a virtual currency with no stable derivative to a government-recognized currency;
electronically assigning a quantity of the currency to at least one user account;
offering at least one tangible item in a multi-user competitive purchasing process;
accepting an offer from a user associated with the user account, the offer being a promise to exchange a quantity of virtual currency for the tangible item;
carrying out the multi-user competitive purchasing process;
determining a winner of the competitive purchasing process; and
assigning ownership of the tangible item to the winner of the competitive purchasing process.

2. The method according to claim 1, further comprising:
decreasing the quantity of the currency in the winning user's user account by an amount corresponding to the amount of virtual currency needed to win the competitive purchasing process.

3. The method according to claim 1, wherein the multi-user competitive purchasing process comprises:
an auction-style bidding process.

4. The method according to claim 1, wherein the multi-user competitive purchasing process comprises:
a lottery-style selection competition.

5. The method according to claim 4, wherein:
entry into the lottery-style selection competition is affected by a user's participation in an auction-style bidding process.

6. The method according to claim 1, wherein the multi-user competitive purchasing process comprises:
a slot-machine-style selection competition.

7. The method according to claim 1, further comprising:
actively preventing a reliable conversion or exchange rate between the virtual currency and the government-recognized currency.

8. The method according to claim 1, wherein the step of electronically assigning a quantity of the currency to the at least one user account comprises:
rewarding a user of the at least one user account for at least one of:
an offline action; and
an interaction with a third party.

9. The method according to claim 1, wherein a total amount of the virtual currency is unobservable to an end user.

10. The method according to claim 1, wherein the multi-user competitive purchasing process includes a lottery and the method further comprises:
selecting a winner of the lottery;
providing the lottery winner an opportunity to claim the lottery jackpot; and
receiving instructions to apply virtual currency to attack an ability of the lottery winner to claim the lottery jackpot.

11. A computer-implemented method of purchasing real-world items with virtual currency, the method comprising:
defining, at a server, a virtual currency with no stable derivative to a government-recognized currency;
establishing an electronic connection between a first personal computer and the server;
determining, with the server, at least one action engaged in by a user of the first personal computer;
electronically assigning a quantity of the virtual currency to an account associated with the user of the first personal computer based on the at least one action;
electronically communicating an offer of at least one tangible item to at least two users;
establishing an electronic connection between the first personal computer, a second personal computer, and the server and facilitating a multi-user competitive purchasing process;
determining a winner of the competitive purchasing process; and
assigning ownership of the tangible item to the winner of the competitive purchasing process.

12. The method according to claim 11, further comprising:
decreasing the quantity of the virtual currency in the winning user's user account by an amount corresponding to the amount of virtual currency needed to win the competitive purchasing process.

13. The method according to claim 11, wherein the multi-user competitive purchasing process comprises:
an auction-style bidding process.

14. The method according to claim 11, wherein the multi-user competitive purchasing process comprises:
a lottery-style selection competition.

15. The method according to claim 11, wherein:
entry into the lottery-style selection competition is affected by a user's participation in an auction-style bidding process.

16. The method according to claim 11, wherein the multi-user competitive purchasing process comprises:
a slot-machine-style selection competition.

17. The method according to claim 11, further comprising:
actively preventing a reliable conversion or exchange rate between the virtual currency and the government-recognized currency.

18. An article of manufacture comprising a machine-readable storage medium storing instructions which, when executed by a processing system, cause the processing system to perform a method, the method comprising:
defining a virtual currency with no stable derivative to a government-recognized currency;
electronically assigning a quantity of the currency to at least one user account;
offering at least one tangible item in a multi-user competitive purchasing process;
accepting an offer from a user associated with the user account, the offer being a promise to exchange a quantity of virtual currency for the tangible item;
carrying out the multi-user competitive purchasing process;
determining a winner of the competitive purchasing process; and
assigning ownership of the tangible item to the winner of the competitive purchasing process.
